(19) United States
(12) Patent Application Publication
(10) Pub. No.: US 2026/0197373 A1
(43) Pub. Date: Jul. 9, 2026

(54) SCHEDULING EVENTS IN A VIRTUAL ENVIRONMENT

(71) Applicant: International Business Machines Corporation, Armonk, NY (US)

(72) Inventors: Charan Acharya Chandrashekar, Bangalore (IN); Raja Rahul, Visakhapatnam (IN)

(21) Appl. No.: 19/009,249

(22) Filed: Jan. 3, 2025

(51) Int. Cl. H04L 67/131; G06Q 50/00; H04L 67/50

(52) U.S. Cl. CPC H04L 67/535; G06Q 10/42; G06Q 10/44; H04L 12/1818

(57) ABSTRACT

A computer-implemented method for managing virtual spaces is provided. A processor set monitors a number of users in a virtual environment to generate historical user activities and real-time activities for the number of users. The processor set identifies a number of trending topics for the number of users based on the historical user activities and the real-time user activities. The processor set classifies the number of users into a number of clusters based on common interests between the number of users identified from the historical user activities and the real-time activities. The processor set determines a time period for an event for a first trending topic from the number of trending topics based on user activities from users classified in the first cluster. The processor set automatically creates a virtual space in the virtual environment for the event for the first trending topic at the time period.

### BACKGROUND

The disclosure relates generally to managing virtual spaces in a virtual environment and more specifically to managing virtual spaces in a virtual environment for scheduling events in the virtual environment.

A virtual environment is a computer-generated space designed to simulate real-world or imaginary settings. Metaverse is an example of a virtual environment that includes immersive digital space where users can interact with each other and objects in the virtual environment in real-time. In this case, virtual environments such as metaverse merges aspects of augmented reality (AR), virtual reality (VR), and digital platforms to create an interconnected virtual world.

Unlike traditional online experiences, virtual environments such as metaverse can either replicate real-world settings such as a virtual office or city, or present entirely fictional worlds such as fantasy realms in video games. These environments allow users to create digital identities, engage in social activities, work, attend events, play games, and explore virtual spaces in the virtual environment through digital avatars. In this case, technologies like VR and AR enhance the immersion by creating a sense of presence, making users feel like they are physically in the environment.

### SUMMARY

According to one illustrative embodiment, a computer-implemented method for managing virtual spaces is provided. A processor set monitors a number of users in a virtual environment to generate historical user activities and real-time activities for the number of users. The processor set identifies a number of trending topics for the number of users based on the historical user activities and the real-time activities for the number of users. The processor set classifies the number of users into a number of clusters based on common interests between the number of users identified from the historical user activities and the real-time activities. Each cluster in the number of clusters represents a trending topic from the number of trending topics. The processor set determines a time period for scheduling an event for a first trending topic from the number of trending topics based on historical user activities from users classified in the first cluster for the first trending topic. The processor set automatically creates a virtual space in the virtual environment for the event for the first trending topic at the time period. According to other illustrative embodiments, a computer system, and a computer program product for optimizing memory usage are provided.

### BRIEF DESCRIPTION OF THE DRAWINGS

FIG. 1 is a pictorial representation of a computing environment in which illustrative embodiments may be implemented;

FIG. 2 is an illustration of a block diagram of a virtual spaces management environment in accordance with an illustrative embodiment;

FIG. 3 is an illustration of a process flow for managing virtual spaces in accordance with an illustrative embodiment;

FIG. 4 is a flowchart of a process for creating virtual spaces in accordance with an illustrative embodiment;

FIG. 5 is a flowchart of a process for identifying a speaker for the event in accordance with an illustrative embodiment; and

FIG. 6 is a block diagram of a data processing system in accordance with an illustrative embodiment.

### DETAILED DESCRIPTION

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one or more storage media (also called “mediums”) collectively included in a set of one or more storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation, or garbage collection, but this does not render the storage device as transitory because the data is not transitory while it is stored.

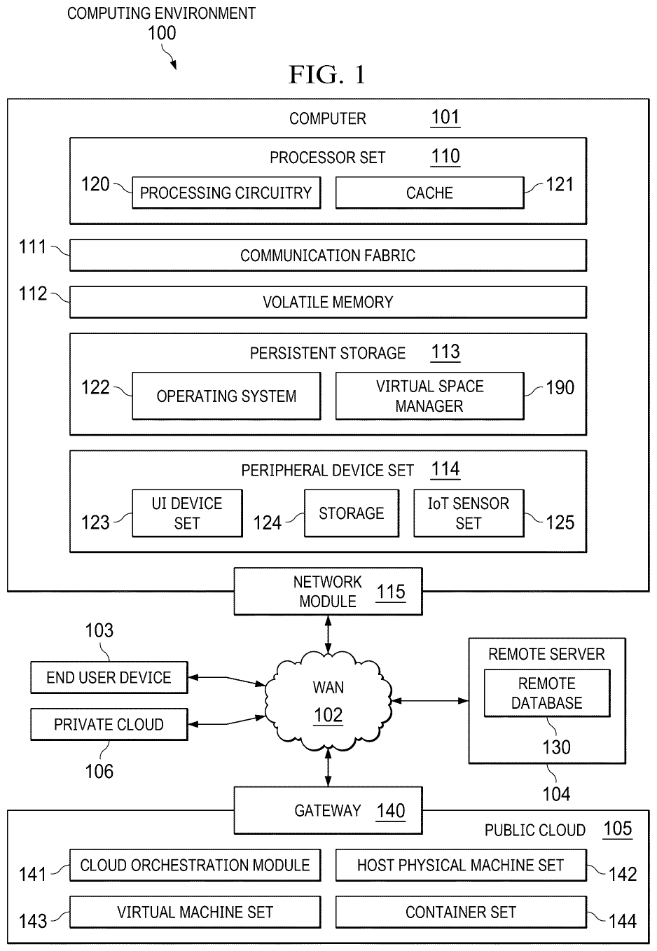

With reference now to the figures, and in particular with reference to FIG. 1, a block diagram of a computing environment is depicted in accordance with an illustrative embodiment. Computing environment 100 contains an example of an environment for the execution of at least some of the computer code involved in performing the inventive methods, such as virtual space manager 190. In addition to virtual space manager 190, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and virtual space manager 190, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one or more computer processors of any type now known or to be developed in the future. Processing circuitry 120 may be distributed over multiple packages, for example, multiple coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions and associated data are accessed by processor set 110 to control and direct performance of the inventive methods. In computing environment 100, at least some of the instructions for performing the inventive methods may be stored in virtual space manager 190 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, volatile memory 112 is located in a single package and is internal to computer 101, but, alternatively or additionally, volatile memory 112 may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data, and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in virtual space manager 190 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers, and edge servers.

END USER DEVICE (EUD) 103 is any computer system that is used and controlled by an end user (for example, a customer of an enterprise that operates computer 101) and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as a thin client, heavy client, mainframe computer, desktop computer, and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data application portability between the multiple constituent clouds. In this embodiment, public cloud 105 and private cloud 106 are both part of a larger hybrid cloud.

CLOUD COMPUTING SERVICES AND/OR MICROSERVICES: Public cloud 105 and private cloud 106 are programmed and configured to deliver cloud computing services and/or microservices (not separately shown in FIG. 1). Unless otherwise indicated, the word “microservices” shall be interpreted as inclusive of larger “services” regardless of size. Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to an “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (Saas) where software is centrally hosted and allocated on a subscription basis. SaaS is also known as on-demand software, web-based software, or web-hosted software. Four technological sub-fields involved in cloud services are: deployment, integration, on demand, and virtual private networks.

The illustrative embodiments recognize and take into account one or more different considerations as described herein. For example, the illustrative embodiments recognize and take into account that the virtual environments are designed to mimic the real world in many ways, including economy, social structures, and rules.

The illustrative embodiments also recognize and take into account that events are manually planned and set up by organizers in virtual environments now. In this case, the organizers need to plan the event, identify participants, and decide on locations for events. The illustrative embodiments also recognize and take into account that manually planning and hosting events in virtual environments require a tremendous amount of time, labor, and cost.

The illustrative embodiments also recognize and take into account that currently in virtual environments, the organizers of events will not know if there is a real demand for a given topic to host an event and which users are interested in attending.

Thus, illustrative embodiments of the present invention provide a computer implemented method, computer system, and computer program product for managing spaces for events in a virtual environment. A processor set monitors a number of users in a virtual environment to generate historical user activities and real-time activities for the number of users. The processor set identifies a number of trending topics for the number of users based on the historical user activities and the real-time activities for the number of users. The processor set classifies the number of users into a number of clusters based on common interests between the number of users identified from the historical user activities and the real-time activities. Each cluster in the number of clusters represents a trending topic from the number of trending topics. The processor set determines a time period for scheduling an event for a first trending topic from the number of trending topics based on historical user activities from users classified in the first cluster for the first trending topic. The processor set automatically creates a virtual space in the virtual environment for the event for the first trending topic at the time period.

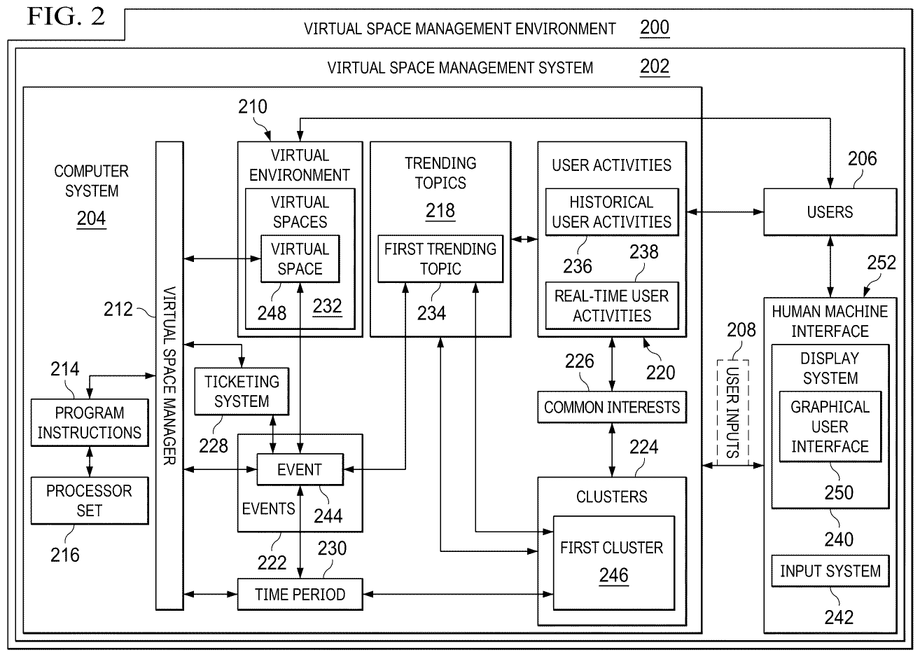

With reference now to FIG. 2, an illustration of a block diagram of a virtual space management environment is depicted in accordance with an illustrative embodiment. In this illustrative example, virtual space management environment 200 includes components that can be implemented in hardware such as the hardware shown in computing environment 100 in FIG. 1.

In this illustrative example, virtual space management system 202 in virtual space management environment 200 can be used to create events and manage virtual spaces 232 for events 222 in virtual environment 210. As depicted, virtual environment 210 is a collective computer-generated space designed to simulate real-world or imaginary settings. For example, virtual environment 210 can be metaverse that is accessible to users 206 through the use of virtual reality (VR) and augmented reality (AR) headsets. In this illustrative example, virtual space management system 202 includes computer system 204 which includes virtual space manager 212. Virtual space manager 212 is located in computer system 204. Virtual space manager 212 may be implemented using virtual space manager 190 in FIG. 1.

Virtual space manager 212 can be implemented in software, hardware, firmware, or a combination thereof. When software is used, the operations performed by virtual space manager 212 can be implemented in program instructions configured to run on hardware, such as a processor unit. When firmware is used, the operations performed by virtual space manager 212 can be implemented in program instructions and data and stored in persistent memory to run on a processor unit. When hardware is employed, the hardware can include circuits that operate to perform the operations in virtual space manager 212.

In the illustrative examples, the hardware can take a form selected from at least one of a circuit system, an integrated circuit, an application specific integrated circuit (ASIC), a programmable logic device, or some other suitable type of hardware configured to perform a number of operations. With a programmable logic device, the device can be configured to perform the number of operations. The device can be reconfigured at a later time or can be permanently configured to perform the number of operations. Programmable logic devices include, for example, a programmable logic array, a programmable array logic, a field programmable logic array, a field programmable gate array, and other suitable hardware devices. Additionally, the processes can be implemented in organic components integrated with inorganic components and can be comprised entirely of organic components excluding a human being. For example, the processes can be implemented as circuits in organic semiconductors.

As used herein, “a number of” when used with reference to items, means one or more items. For example, “a number of operations” is one or more operations.

Further, the phrase “at least one of,” when used with a list of items, means different combinations of one or more of the listed items can be used, and only one of each item in the list may be needed. In other words, “at least one of” means any combination of items and number of items may be used from the list, but not all of the items in the list are required. The item can be a particular object, a thing, or a category.

For example, without limitation, “at least one of item A, item B, or item C,” may include item A, item A and item B, or item B. This example also may include item A, item B, and item C, or item B and item C. Of course, any combination of these items can be present. In some illustrative examples, “at least one of” can be, for example, without limitation, two of item A; one of item B; and ten of item C; four of item B and seven of item C; or other suitable combinations.

Computer system 204 is a physical hardware system and includes one or more data processing systems. When more than one data processing system is present in computer system 204, those data processing systems are in communication with each other using a communications medium. The communications medium can be a network. The data processing systems can be selected from at least one of a computer, a server computer, a tablet computer, or some other suitable data processing system.

As depicted, computer system 204 includes processor set 216 that is capable of executing program instructions 214 implementing processes in the illustrative examples. In other words, program instructions 214 are computer-readable program instructions.

As used herein, a processor unit in processor set 216 is a hardware device and is comprised of hardware circuits such as those on an integrated circuit that respond to and process instructions and program code that operate a computer. A processor unit can be implemented using processor set 110 in FIG. 1. When processor set 216 executes program instructions 214 for a process, processor set 216 can be one or more processor units that are in the same computer or in different computers. In other words, the process can be distributed between processor set 216 on the same or different computers in computer system 204.

Further, processor set 216 can be of the same type or different types of processor units. For example, processor set 216 can be selected from at least one of a single core processor, a dual-core processor, a multi-processor core, a general-purpose central processing unit (CPU), a graphics processing unit (GPU), a digital signal processor (DSP), or some other type of processor unit.

In this illustrative example, virtual space manager 212 can monitor users 206 to generate user activities 220. In this illustrative example, user activities 220 includes historical user activities 236 and real-time user activities 238. Real-time user activities 238 are actions or behaviors performed by users 206 that are monitored, tracked, or processed instantly as they occur. On the other hand, historical user activities 236 are actions or behaviors performed by users 206 that are monitored, tracked, or processed over time.

In this illustrative example, historical user activities 236 and real-time user activities 238 encompass a variety of activities. For example, historical user activities 236 and real-time user activities 238 can include voices from users 206, messages from users 206, interactions between users in users 206, interactions between users 206 and virtual objects in virtual environment 210, or any suitable activities from users 206 as users 206 explore virtual environment 210.

Virtual space manager 212 can identify a number of trending topics 218. In this illustrative example, the number of trending topics 218 can be pre-defined by developers of virtual environment 210. In an alternative illustrative example, virtual space manager 212 can also identify the number of trending topics 218 based on historical user activities 236 and real-time user activities 238 from user activities 220. The number of trending topics 218 are subjects that are currently popular and widely discussed across users from users 206.

In this illustrative example, the number of trending topics 218 can be identified using natural language processing techniques that understand demand for subjects discussed by users from users 206 by analyzing textual data and extracting meaningful insights from historical user activities 236 and real-time user activities 238. In addition, avatar's expression, reactions, and body languages for users 206 can be analyzed to identify the number of trending topics 218.

In this illustrative example, a variety of natural language processing techniques can be used for identifying the number of trending topics 218. For example, virtual space manager 212 can use text classification, keyword extraction, trend analysis, sentiment analysis, topic modelling, or any suitable natural language processing techniques. In addition, virtual space manager 212 can utilize temporal analysis to plot time series maps to determine trends based on historical user activities 236 and real-time user activities 238. In this example, temporal analysis can be helpful to determine demand for a particular topic in the number of trending topics 218 over time.

In this illustrative example, virtual space manager 212 can further identify common interests 226 for users 206 based on historical user activities 236 and real-time user activities 238. Common interests 226 are shared preferences, hobbies, or activities between users from users 206. In this illustrative example, virtual space manager 212 can classify users from users 206 into a number of clusters 224. Each cluster in clusters 224 represents a trending topic from first trending topic 234. For example, first cluster 246 from clusters 224 can represent first trending topic 234 from the number of trending topics 218. In other words, first cluster 246 corresponds to a portion of users in users 206 that are interested in first trending topic 234.

In this illustrative example, clusters 224 can be identified using a number of techniques. For example, clusters 224 can be identified using K-means clustering algorithm or any suitable clustering algorithm. In this illustrative example, the demand for a trending topic in trending topics 218 can be measured using the number of users interested in the topic.

In this illustrative example, virtual space manager 212 can be used to schedule events 222 for users 206 in virtual spaces 232 contained in virtual environment 210. Events 222 can be planned and scheduled based on trending topics 218. For example, if virtual space manager 212 determines that first trending topic 234 is in demand and discussed by a number of users from users 206 that exceeds a threshold, virtual space manager 212 can schedule event 244 for the first trending topic 234. In other words, virtual space manager 212 can schedule event 244 for first trending topic 234 based on historical user activities and real-time user activities from users classified in first cluster 246. In this illustrative example, events 222 such as event 244 can be concerts, conferences, social gatherings, parties, gaming tournaments, fashion shows, or any suitable event.

In this illustrative example, virtual space manager 212 can determine time period 230 for event 244. Time period 230 can be determined based on users'availability determined based on user activities 220. For example, time period 230 can be a time slot that is available for maximal number of users that are classified in first cluster 246. In this illustrative example, virtual space manager 212 can also identify a speaker for event 244 based on expertise levels of speakers and availability of speakers during time period 230.

In this illustrative example, information associated with event 244 can be fed into ticketing system 228 and users classified in first cluster 246 can be registered using ticketing system 228. Subsequently, virtual space manager 212 can create virtual space 248 for event 244 and use ticketing system 228 to register participants for event 244. In this illustrative example, virtual space 248 can be created in a venue selected based on the number of participants registered for event 244.

In this illustrative example, users 206 can interact with virtual environments 210 in computer system 204 via user inputs 208. User inputs 208 can be generated by users 206 using human machine interface (HMI) 252. As depicted, human machine interface 252 includes display system 240 and input system 242. Display system 240 is a physical hardware system and includes one or more display devices on which graphical user interface 250 can be displayed. The display devices can include at least one of a light emitting diode (LED) display, an organic light emitting diode (OLED) display, a computer monitor, a projector, a flat panel display, a heads-up display (HUD), a head-mounted display (HMD), smart glasses, augmented reality glasses, virtual reality headsets, or some other suitable device that can output information for the visual presentation of information.

In this example, users 206 are people that can interact with graphical user interface 250 through user inputs 208 generated by input system 242. Input system 242 is a physical hardware system and can be selected from at least one of a mouse, a keyboard, a touch pad, a trackball, a touchscreen, a stylus, a motion sensing input device, a gesture detection device, a data glove, a cyber glove a haptic feedback device, or some other suitable type of input device. For example, users 206 can view virtual environment 210 and events 222 through graphical user interface 250 and interact with virtual environment 210 as well as other users in virtual environment 210 through graphical user interface 250. In addition, users 206 can also view notifications for events 222 on graphical user interface 250.

In one illustrative example, one or more solutions are present that overcome a problem with automatically planning events in virtual environments and managing virtual spaces in the virtual environments. As a result, one or more technical solutions may provide an ability to increase the efficiency for managing virtual spaces 232 in virtual environment 210 for computer system 204.

In the illustrative example, computer system 204 can be configured to perform at least one of the steps, operations, or actions described in the different illustrative examples using software, hardware, firmware, or a combination thereof. As a result, computer system 204 operates as a special purpose computer system in which virtual space manager 212 in computer system 204 enables automating event planning in virtual environments such as virtual environment 210. In particular, virtual space manager 212 transforms computer system 204 into a special purpose computer system as compared to currently available general computer systems that do not have a virtual space manager 212.

In the illustrative example, the use of virtual space manager 212 in computer system 204 integrates processes into a practical application for automating event planning in virtual environments such as virtual environment 210, because virtual space manager 212 automates event planning in virtual environments such that virtual spaces can be dynamically managed by efficiently allocating computer resources such as memory from computer system 204. In other words, virtual space that takes memory in computer system 204 and virtual space manager 212 can dynamically manage virtual space creation and virtual space deletions to efficiently allocate memory in computer system 204

The illustration of virtual space management environment 200 in FIG. 2 is not meant to imply physical or architectural limitations to the manner in which an illustrative embodiment can be implemented. Other components in addition to or in place of the ones illustrated may be used. Some components may be unnecessary. Also, the blocks are presented to illustrate some functional components. One or more of these blocks may be combined, divided, or combined and divided into different blocks when implemented in an illustrative embodiment. For example, virtual space manager 212 can further utilize a log that keeps information associated with levels of expertise for each speaker. In this example, virtual space manager 212 can update the level of expertise for speakers after attending events in virtual environment 210 based on feedback and reviews from users that also attend the same events.

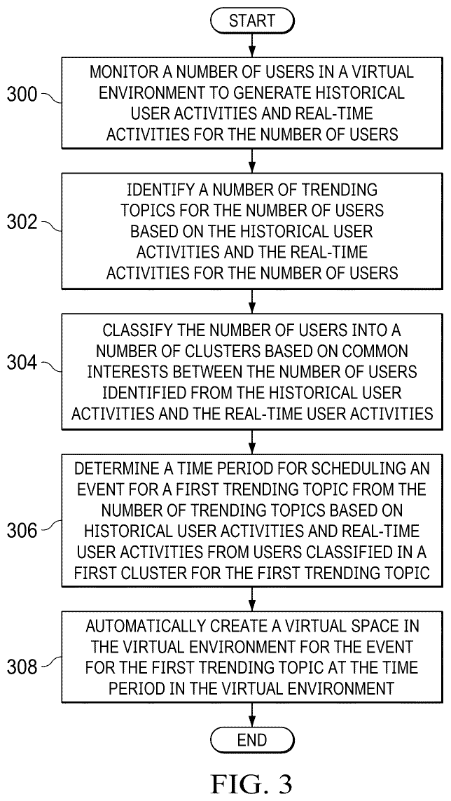

With reference now to FIG. 3, a flowchart illustrating a process for managing virtual spaces is shown in accordance with an illustrative embodiment. The process in FIG. 3 can be implemented in hardware, software, or both. When implemented in software, the process can take the form of program instructions that are run by one of more processor units located in one or more hardware devices in one or more computer systems. For example, the process can be implemented in virtual space manager 212 in computer system 204 in FIG. 2.

The process begins by monitoring a number of users in a virtual environment to generate historical user activities and real-time activities for the number of users (step 300). The process identifies a number of trending topics for the number of users based on the historical user activities and the real-time activities for the number of users (step 302).

The process classifies the number of users into a number of clusters based on common interests between the number of users identified from the historical user activities and the real-time user activities (step 304). In step 304, each cluster in the number of clusters represents a trending topic from the number of trending topics. The process determines a time period for scheduling an event for a first trending topic from the number of trending topics based on historical user activities and real-time user activities from users classified in a first cluster for the first trending topic (step 306).

The process automatically creates a virtual space in the virtual environment for the event for the first trending topic at the time period in the virtual environment (step 308). The process terminates thereafter.

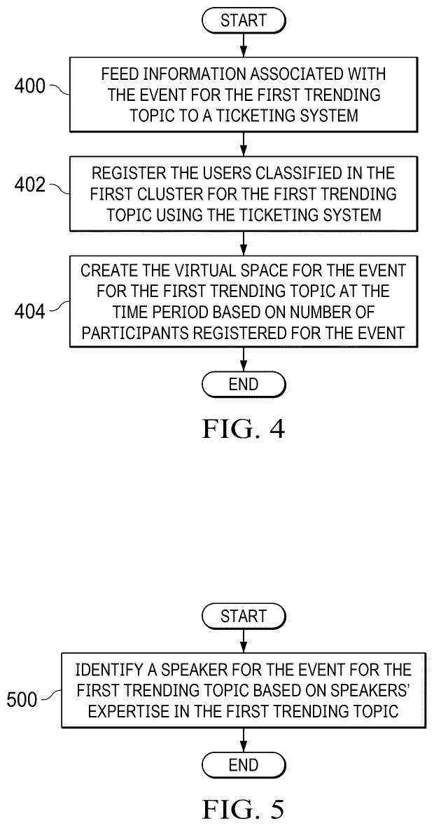

Turning next to FIG. 4, a flowchart of a process for creating virtual spaces is depicted in accordance with an illustrative embodiment. The process in this flowchart is an example of an implementation for step 308 in FIG. 3.

The process begins by feeding information associated with the event for the first trending topic to a ticketing system (step 400). The process registers the users classified in the first cluster for the first trending topic using the ticketing system (step 402). The process creates the virtual space for the event for the first trending topic at the time period based on the number of participants registered for the event (step 404). The process terminates thereafter.

Turning next to FIG. 5, a flowchart of a process for identifying a speaker for the event is depicted in accordance with an illustrative embodiment. The process in this figure is an example of an additional step that can be performed with the steps in FIG. 3.

The process begins by identifying a speaker for the event for the first trending topic based on speakers'expertise in the first trending topic (step 500). The process terminates thereafter.

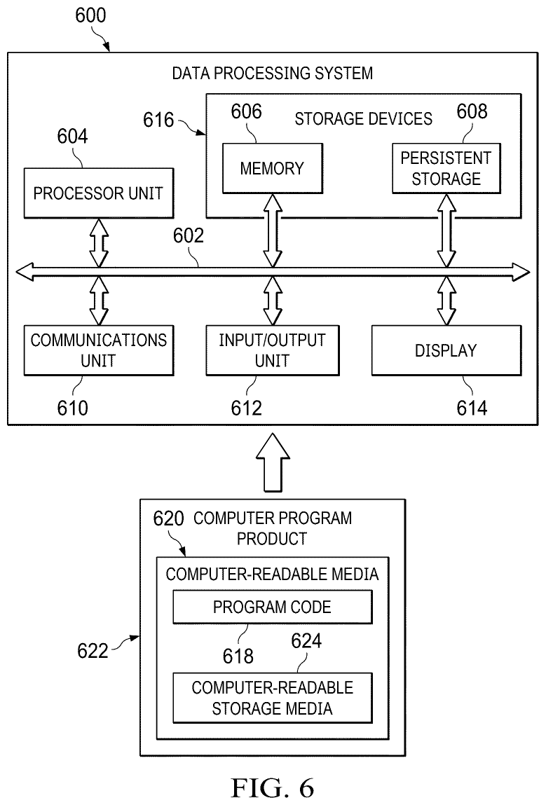

Turning now to FIG. 6, a block diagram of a data processing system is depicted in accordance with an illustrative embodiment. Data processing system 600 can be used to implement computers and computing devices in computing environment 100 in FIG. 1. Data processing system 600 can also be used to implement computer system 204 in FIG. 2. In this illustrative example, data processing system 600 includes communications framework 602, which provides communications between processor unit 604, memory 606, persistent storage 608, communications unit 610, input/output (I/O) unit 612, and display 614. In this example, communications framework 602 takes the form of a bus system.

Processor unit 604 serves to execute instructions for software that can be loaded into memory 606. Processor unit 604 includes one or more processors. For example, processor unit 604 can be selected from at least one of a multicore processor, a central processing unit (CPU), a graphics processing unit (GPU), a physics processing unit (PPU), a digital signal processor (DSP), a network processor, or some other suitable type of processor. Further, processor unit 604 can be implemented using one or more heterogeneous processor systems in which a main processor is present with secondary processors on a single chip. As another illustrative example, processor unit 604 can be a symmetric multi-processor system containing multiple processors of the same type on a single chip.

Memory 606 and persistent storage 608 are examples of storage devices 616. A storage device is any piece of hardware that is capable of storing information, such as, for example, without limitation, at least one of data, program instructions in functional form, or other suitable information either on a temporary basis, a permanent basis, or both on a temporary basis and a permanent basis. Storage devices 616 may also be referred to as computer-readable storage devices in these illustrative examples. Memory 606, in these examples, can be, for example, a random-access memory or any other suitable volatile or non-volatile storage device. Persistent storage 608 may take various forms, depending on the particular implementation.

For example, persistent storage 608 may contain one or more components or devices. For example, persistent storage 608 can be a hard drive, a solid-state drive (SSD), a flash memory, a rewritable optical disk, a rewritable magnetic tape, or some combination of the above. The media used by persistent storage 608 also can be removable. For example, a removable hard drive can be used for persistent storage 608.

Communications unit 610, in these illustrative examples, provides for communications with other data processing systems or devices. In these illustrative examples, communications unit 610 is a network interface card.

Input/output unit 612 allows for input and output of data with other devices that can be connected to data processing system 600. For example, input/output unit 612 may provide a connection for user input through at least one of a keyboard, a mouse, or some other suitable input device. Further, input/output unit 612 may send output to a printer. Display 614 provides a mechanism to display information to a user.

Instructions for at least one of the operating system, applications, or programs can be located in storage devices 616, which are in communication with processor unit 604 through communications framework 602. The processes of the different embodiments can be performed by processor unit 604 using computer-implemented instructions, which may be located in a memory, such as memory 606.

These instructions are referred to as program instructions, computer usable program instructions, or computer-readable program instructions that can be read and executed by a processor in processor unit 604. The program instructions in the different embodiments can be embodied on different physical or computer-readable storage media, such as memory 606 or persistent storage 608.

Program instructions 618 are located in a functional form on computer-readable media 620 that is selectively removable and can be loaded onto or transferred to data processing system 600 for execution by processor unit 604. Program instructions 618 and computer-readable media 620 form computer program product 622 in these illustrative examples. In the illustrative example, computer-readable media 620 is computer-readable storage media 624.

Computer-readable storage media 624 is a physical or tangible storage device used to store program instructions 618 rather than a medium that propagates or transmits program instructions 618. Computer-readable storage media 624, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Alternatively, program instructions 618 can be transferred to data processing system 600 using a computer-readable signal media. The computer-readable signal media are signals and can be, for example, a propagated data signal containing program instructions 618. For example, the computer-readable signal media can be at least one of an electromagnetic signal, an optical signal, or any other suitable type of signal. These signals can be transmitted over connections, such as wireless connections, optical fiber cable, coaxial cable, a wire, or any other suitable type of connection.

Further, as used herein, “computer-readable media 620” can be singular or plural. For example, program instructions 618 can be located in computer-readable media 620 in the form of a single storage device or system. In another example, program instructions 618 can be located in computer-readable media 620 that is distributed in multiple data processing systems. In other words, some instructions in program instructions 618 can be located in one data processing system while other instructions in program instructions 618 can be located in one data processing system. For example, a portion of program instructions 618 can be located in computer-readable media 620 in a server computer while another portion of program instructions 618 can be located in computer-readable media 620 located in a set of client computers.

The different components illustrated for data processing system 600 are not meant to provide architectural limitations to the manner in which different embodiments can be implemented. In some illustrative examples, one or more of the components may be incorporated in or otherwise form a portion of another component. For example, memory 606, or portions thereof, may be incorporated in processor unit 604 in some illustrative examples. The different illustrative embodiments can be implemented in a data processing system including components in addition to or in place of those illustrated for data processing system 600. Other components shown in FIG. 6 can be varied from the illustrative examples shown. The different embodiments can be implemented using any hardware device or system capable of running program instructions 618.

Thus, illustrative embodiments of the present disclosure provide a computer-implemented method, computer system, and computer program product for managing containers. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

The description of the different illustrative embodiments has been presented for purposes of illustration and description and is not intended to be exhaustive or limited to the embodiments in the form disclosed. The different illustrative examples describe components that perform actions or operations. In an illustrative embodiment, a component can be configured to perform the action or operation described. For example, the component can have a configuration or design for a structure that provides the component an ability to perform the action or operation that is described in the illustrative examples as being performed by the component. Further, to the extent that terms “includes”, “including”, “has”, “contains”, and variants thereof are used herein, such terms are intended to be inclusive in a manner similar to the term “comprises” as an open transition word without precluding any additional or other elements.

The descriptions of the various embodiments of the present invention have been presented for purposes of illustration but are not intended to be exhaustive or limited to the embodiments disclosed. Not all embodiments will include all of the features described in the illustrative examples. Further, different illustrative embodiments may provide different features as compared to other illustrative embodiments. Many modifications and variations will be apparent to those of ordinary skill in the art without departing from the scope and spirit of the described embodiment. The terminology used herein was chosen to best explain the principles of the embodiment, the practical application or technical improvement over technologies found in the marketplace, or to enable others of ordinary skill in the art to understand the embodiments disclosed here.

1. A computer implemented method for managing virtual spaces, the computer implemented method comprising:
monitoring, by a processor set, a number of users in a virtual environment to generate historical user activities and real-time activities for the number of users, wherein the virtual environment is a collective computer-generated space designed to simulate imaginary settings, and wherein the virtual environment is accessible to the number of users through use of virtual reality and augmented reality;
identifying, by the processor set, a number of trending topics for the number of users based on the historical user activities and the real-time user activities for the number of users;
classifying, by the processor set, the number of users into a number of clusters based on common interests between the number of users identified from the historical user activities and the real-time activities, wherein each cluster in the number of clusters represents a trending topic from the number of trending topics;
determining, by the processor set, a time period for scheduling an event for a first trending topic from the number of trending topics based on historical user activities and real-time user activities from users classified in the first cluster for the first trending topic, wherein the time period is selected based on a time slot that is available for maximal number of users that are classified in the first cluster; and
automatically creating, by the processor set, a virtual space in the virtual environment for the event for the first trending topic at the time period.

2. The computer implemented method of claim 1, wherein the creating, by the processor set, a virtual space for the event for the first trending topic at the time period in the virtual environment comprises:
feeding, by the processor set, information associated with the event for the first trending topic to a ticketing system;
registering, by the processor set using the ticketing system, the users classified in the first cluster for the first trending topic; and
creating, by the processor set, the virtual space for the event for the first trending topic at the time period based on number of participants registered for the event.

3. The computer implemented method of claim 1, further comprising:
identifying, by the processor set, a speaker for the event for the first trending topic based on speakers'expertise in the first trending topic.

4. The computer implemented method of claim 3, wherein expertise for the speaker is updated after the event is completed.

5. The computer implemented method of claim 1, wherein the number of trending topics are identified based on the historical user activities and the real-time activities for the number of users using natural language processing.

6. The computer implemented method of claim 1, wherein the historical user activities and real-time activities for the number of users comprise at least one of voices from the number of users, interactions between the number of users and virtual objects in the virtual environment, and messages between the number of users.

7. The computer implemented method of claim 1, wherein the number of trending topics are identified by performing temporal analysis on the historical user activities to determine trends of topics over time.

8. A computer system for managing virtual spaces, comprising:
a processor set;
a set of one or more computer-readable storage media; and
program instructions stored on the set of one or more storage media to cause the processor set to perform operations comprising:
monitoring a number of users in a virtual environment to generate historical user activities and real-time activities for the number of users, wherein the virtual environment is a collective computer-generated space designed to simulate imaginary settings, and wherein the virtual environment is accessible to the number of users through use of virtual reality and augmented reality;
identifying a number of trending topics for the number of users based on the historical user activities and the real-time user activities for the number of users;
classifying the number of users into a number of clusters based on common interests between the number of users identified from the historical user activities and the real-time user activities, wherein each cluster in the number of clusters represents a trending topic from the number of trending topics;
determining a time period for scheduling an event for a first trending topic from the number of trending topics based on historical user activities and real-time user activities from users classified in the first cluster for the first trending topic, wherein the time period is selected based on a time slot that is available for maximal number of users that are classified in the first cluster; and
automatically creating a virtual space in the virtual environment for the event for the first trending topic at the time period.

9. The computer system of claim 8, wherein the creating a virtual space for the event for the first trending topic at the time period in the virtual environment comprises:
feeding information associated with the event for the first trending topic to a ticketing system;
registering the users classified in the first cluster for the first trending topic using the ticketing system; and
creating the virtual space for the event for the first trending topic at the time period based on number of participants registered for the event.

10. The computer system of claim 9, wherein the operations further comprise:
identifying a speaker for the event for the first trending topic based on speakers'expertise in the first trending topic.

11. The computer system of claim 10, wherein expertise for the speaker is updated after the event is completed.

12. The computer system of claim 8, wherein the number of trending topics are identified based on the historical user activities and the real-time activities for the number of users using natural language processing.

13. The computer system of claim 8, wherein the historical user activities and real-time activities for the number of users comprise at least one of voices from the number of users, interactions between the number of users and virtual objects in the virtual environment, and messages between the number of users.

14. The computer system of claim 8, wherein the number of trending topics are identified by performing temporal analysis on the historical user activities to determine trends of topics over time.

15. A computer program product for managing virtual spaces, comprising:
a set of one or more computer-readable storage media;
program instructions stored in the set of one or more storage media to perform operations comprising:
monitoring, by a processor set, a number of users in a virtual environment to generate historical user activities and real-time activities for the number of users, wherein the virtual environment is a collective computer-generated space designed to simulate imaginary settings, and wherein the virtual environment is accessible to the number of users through use of virtual reality and augmented reality;
identifying, by the processor set, a number of trending topics for the number of users based on the historical user activities and the real-time user activities for the number of users;
classifying, by the processor set, the number of users into a number of clusters based on common interests between the number of users identified from the historical user activities and the real-time activities, wherein each cluster in the number of clusters represents a trending topic from the number of trending topics;
determining, by the processor set, a time period for scheduling an event for a first trending topic from the number of trending topics based on historical user activities and real-time user activities from users classified in the first cluster for the first trending topic, wherein the time period is selected based on a time slot that is available for maximal number of users that are classified in the first cluster; and
automatically creating, by the processor set, a virtual space in the virtual environment for the event for the first trending topic at the time period.

16. The computer program product of claim 15, wherein the creating, by the processor set, a virtual space for the event for the first trending topic at the time period in the virtual environment comprises:
feeding, by the processor set, information associated with the event for the first trending topic to a ticketing system;
registering, by the processor set using the ticketing system, the users classified in the first cluster for the first trending topic; and
creating, by the processor set, the virtual space for the event for the first trending topic at the time period based on number of participants registered for the event.

17. The computer program product of claim 16, wherein the operations further comprise:
identifying, by the processor set, a speaker for the event for the first trending topic based on speakers'expertise in the first trending topic.

18. The computer program product of claim 15, wherein the number of trending topics are identified based on the historical user activities and the real-time activities for the number of users using natural language processing.

19. The computer program product of claim 15, wherein the historical user activities and real-time activities for the number of users comprise at least one of voices from the number of users, interactions between the number of users and virtual objects in the virtual environment, and messages between the number of users.

20. The computer program product of claim 15, wherein the number of trending topics are identified by performing temporal analysis on the historical user activities to determine trends of topics over time.
